(19) United States
(12) Patent Application Publication
(10) Pub. No.: US 2024/0223384 A1
(43) Pub. Date: Jul. 4, 2024

(54) IPU BASED OPERATORS

(71) Applicant: Intel Corporation, Santa Clara, CA (US)

(72) Inventor: Francesc GUIM BERNAT, Barcelona (ES)

(21) Appl. No.: 18/558,155

(22) PCT Filed: Sep. 17, 2021
(86) PCT No.: PCT/US21/50941

§ 371 Date: Oct. 30, 2023

(51) Int. Cl. H04L 9/32

(52) U.S. Cl. CPC H04L 9/3263; H04L 9/3236

(57) ABSTRACT

Methods and apparatus for attestation and execution of operators. The apparatus is configured to be implemented in a compute platform including at least one processing unit, and is configured to perform client-side attestation operations with an operator attestation service to validate an operator to be executed on the apparatus or a processing unit on the compute platform. The apparatus is also configured to fetch an operator from an operator catalog, compute a hash over the operator, and send a message containing the hash and operator identifier (ID) (or digest containing the same with optional signing) to the operator attestation service, which validates the operator by looking up a valid hash for the operator using the operator ID and comparing the hashes. The apparatus is also configured to maintain and enforce tenant rules relating to execution of operators, and includes a cache for caching validated operators.

### BACKGROUND INFORMATION

Data center architectures are rapidly evolving to be capable of allowing rapid provisioning of nodes, autonomous life cycle management of services and seamless updates when needed. Ecosystem players (such as Red Hat, VMware, etc.) are moving towards develop methods that use constructs such as operators to implement the automation, robustness and life cycle management of the entire data center and services. For example, FIG. 1 shows a management lifecycle with five phases: Installation, Upgrades, Lifecycle, Insights, and Auto-pilot. Various custom operators may be required for Phases II-V.

The constructs can be developed on top of multiple types of technologies and languages. For example, software solutions such as but not limited to, Helm (for Kubernetes), Ansible (Infrastructure as code) and the Go programming language can be utilized in different phases of the system configuration and applications deployment and life cycle management depending on the nature of the operators.

This variety of ecosystem players and methods to implement operators will allow rapid evolution in mechanisms to achieve more scalable and autonomous systems. However, one question that comes to my mind is, can I have some mechanism in the data center that allow me to validate, filter and attest operators before they get executed in a particular node? Can I have an infrastructure piece that takes care on their attestation, validation and even execution? There are several things a CSP (Cloud Service Provider) or data center operator may want to prevent:
Operator X is not desired for a particular node. For instance, a node meant to be used using no changes on power states because the real time aspect of applications running on that node. Ansible scripts may change power states on given cores.
Operator X is not trusted or validated for a given node. It may happen that someone acquires credentials or access to a node and executes an operator with a malicious way etc.
Operator X has not been validated for that platform or conflicts with a service running on the node.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a diagram illustrating a management lifecyle:

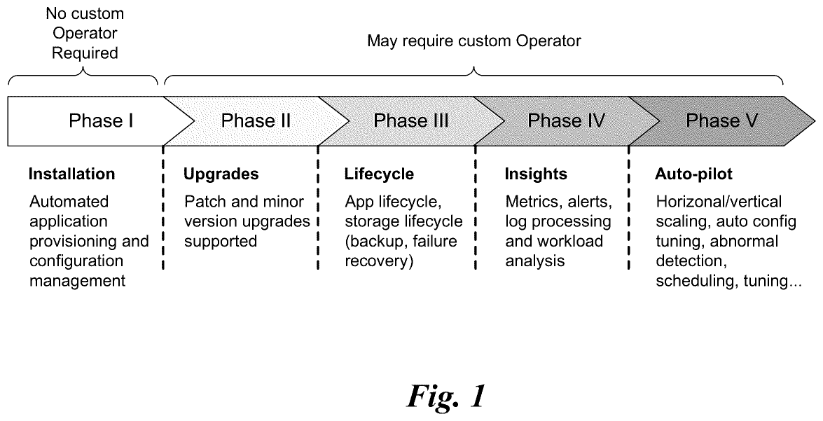

FIG. 2 is a diagram illustrating an example a trust environment employing an IPU, according to one embodiment:

FIG. 3 is a schematic diagram illustrating a high-level architecture of a secure operator deployment environment, according to one embodiment:

FIG. 3a is a schematic diagram illustrating a first variant of the compute platform of FIG. 3 under which an XPU is used in place of a CPU:

FIG. 3b is a schematic diagram illustrating a second variant of the compute platform of FIG. 3 under which the compute platform includes both a CPU and an XPU:

FIG. 4 is a schematic diagram of an architecture focusing on further details of the IPU and how it performs attestation of operators and other functions, according to one embodiment:

FIG. 5 is a flowchart illustrating operations for establishing an authenticated channel to be used for communication between an IPU and a secure server:

FIG. 6 is a flowchart illustrating a process for attesting and validating a particular operator or operation within an operator or operator flow instantiated by a particular source, according to one embodiment:

FIG. 7 is a flowchart illustrating operations and logic performed in response to receiving a new operator request:

FIG. 8 is a diagram illustrating further aspects of an operator attestation service and an operator catalog, according to one embodiment; and

FIG. 9 is a schematic diagram illustrating an IPU, according to one embodiment;

### DETAILED DESCRIPTION

Embodiments of methods and apparatus for attestation and execution of operators are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

### Infrastructure Processing Unit

An IPU is a programmable network device that intelligently manages system-level infrastructure resources by securely accelerating those functions in a data center or similar environment. It allows cloud operators to shift to a fully virtualized storage and network architecture while maintaining high performance and predictability, as well as a high degree of control.

The IPU has dedicated functionality to accelerate modern applications that are built using a microservice-based architecture in the data center. Research from Google and Facebook has shown 22% to 80% of CPU cycles can be consumed by microservices communication overhead. An IPU can dramatically reduce the CPU cycles consumed by microservices communication.

With the IPU, a cloud provider can securely manage infrastructure functions while enabling its customer to entirely control the functions of the CPU and system memory.

Among other capabilities, an IPU offers the ability to:
Accelerate infrastructure functions, including storage virtualization, network virtualization and security with dedicated protocol accelerators.
Free up CPU cores by shifting storage and network virtualization functions that were previously done in software on the CPU to the IPU.
Improve data center utilization by allowing for flexible workload placement.
Enable cloud service providers to customize infrastructure function deployments at the speed of software.

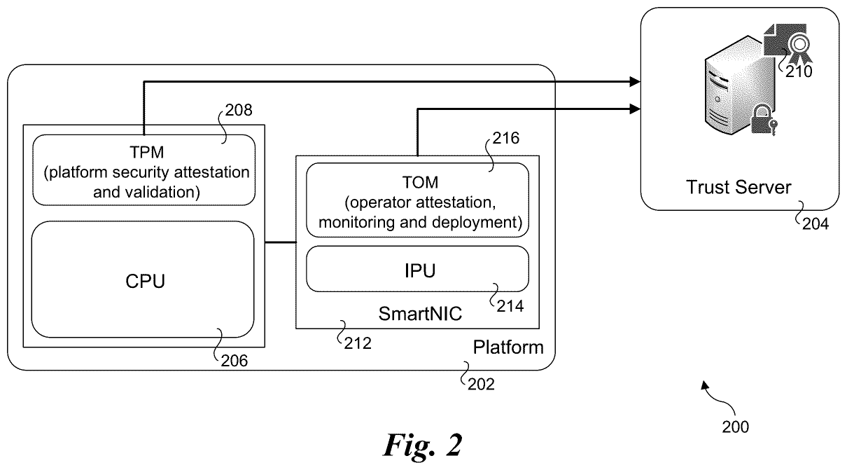

FIG. 2 shows an example of a trust environment 200 employing an IPU, according to one embodiment. Trust environment 200 includes a platform 202 linked in communication with a trust server 204. Platform 202 includes a CPU 206 that employs a trusted platform module (TPM) 208 for platform security attestation and validation. As used herein, a CPU is generally illustrative of a processor and/or System on a Chip (SoC). The TPM is manufactured with a public/private key pair built into the hardware, called the endorsement key (EK). The EK is unique to a particular TPM and is signed by a trusted Certification Authority (CA).

Use of a TPM for platform security attestation and validation generally comprises “measuring” platform firmware and software components, generating one or more hashes, and sending the hashes for trust server 204 for a comparison. Measurement is the process by which information about the software, hardware, and configuration of a system is collected and digested: such measurements may be referred to as digests of be included in a digest concatenated with other data or meta-data. At load-time, the TPM uses a hash function to fingerprint an executable, an executable plus its input data, or a sequence of such files. These hash values are used in attestation to reliably establish code identity to remote or local verifiers, which in this example is trust server 204.

Attestation is a mechanism for firmware and/or software to prove its identity. The goal of attestation is to prove to a remote party that the platform's firmware and/or operating system and (optionally) application software are intact and trustworthy. The verifier trusts that attestation data is accurate because it is signed by a TPM whose key is certified by the CA.

For a given trust environment, trust server 204 will have sets of hashes for deployed platforms and/or nodes, where the hash values correspond to a trusted configuration for what is measured, such as the platform firmware. Trust server 204 will also have a set of certificates 210. If the platform firmware has been hacked, the hashes will not match, and the platform's firmware and or software will not be validated for further operation.

Platform 202 further includes a network interface comprising a SmartNIC 212 including an IPU 214 and a Trusted Operators Module (TOM) 216 that is used for operator attestation, monitoring, and deployment. In one embodiment TOM 216 comprises a second TPM that is used for operator attestation (e.g., attestation of operator software) rather than for attestation of platform firmware and OS, as described in further detail below.

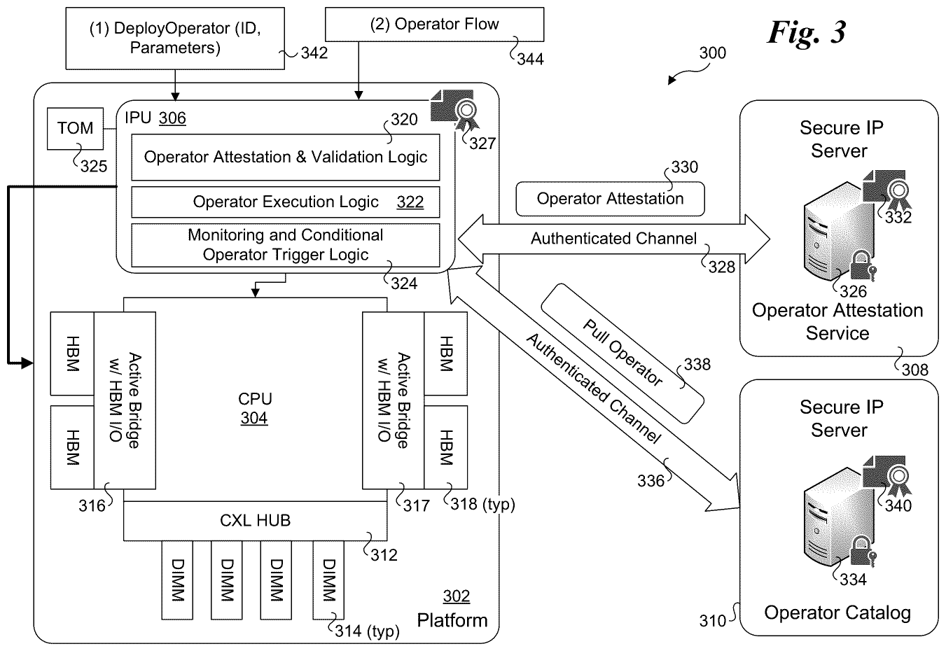

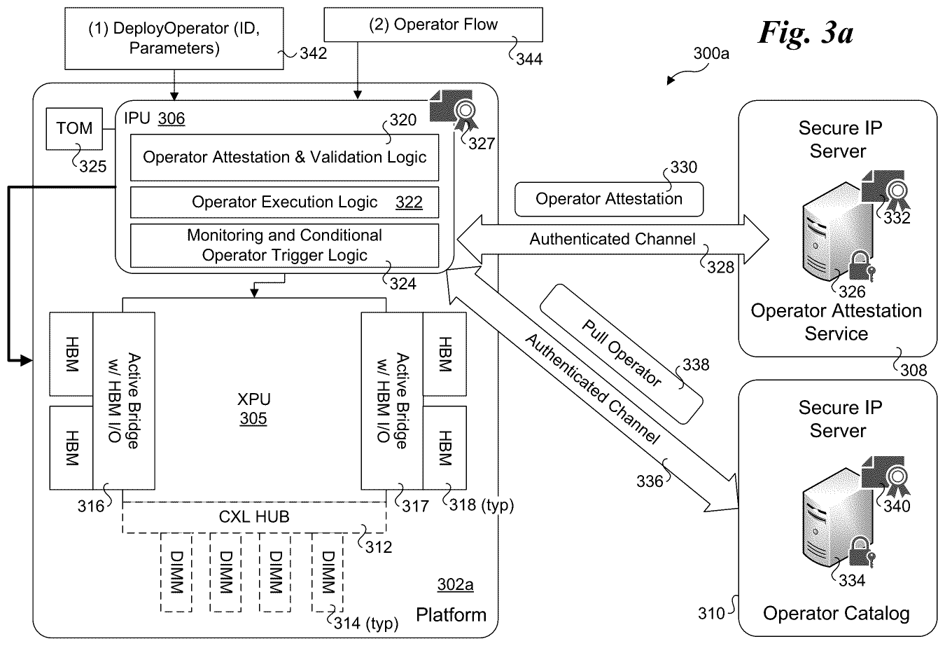

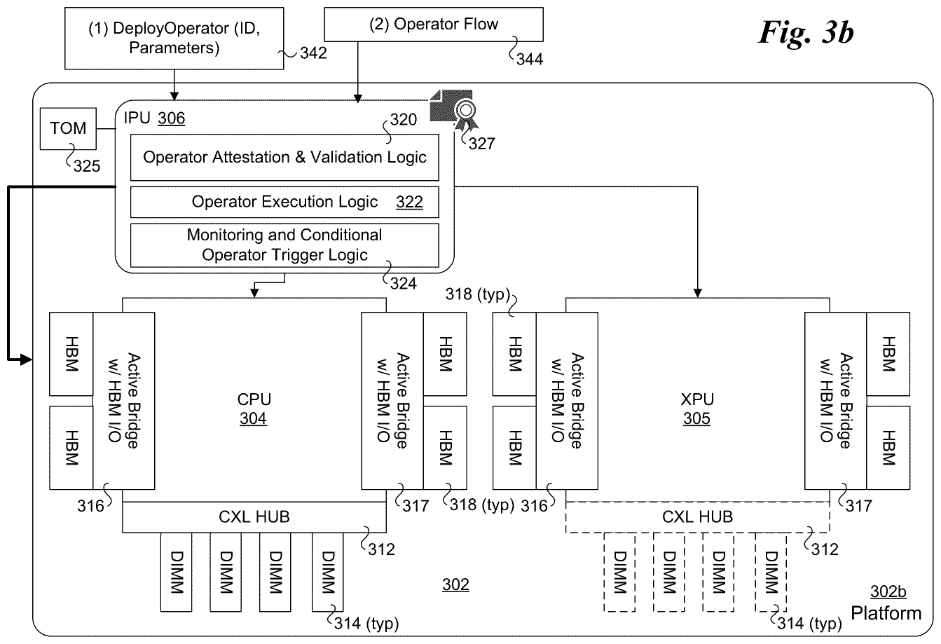

FIG. 3 shows a high-level architecture 300 of a secure operator deployment environment, according to one embodiment. In architecture 300, logic in the IPU/Smart NIC provides exposed functionalities to allow an infrastructure owner to allow control on the execution of operators that software stacks (e.g., instances of Kubernetes, user etc.) may generate against a server. Additionally, the IPU is enabled to act as operator actor if required.

Generally, the IPU is responsible for validating and attesting operators that are being applied to the platform/node itself. In the case that an operator is being executed by a node X to the local node, the logic will be responsible to validate and/or attest every execution or step that the operator sends to the system (e.g., setting frequency of a particular core). This implies that operators' actions against a particular system must be signed with the operator certificate. Beyond attestation, the IPU supports registration and enforcement of rules on what type of operators and actions may be executed to the local system.

The IPU includes logic that enables execution of some operators directly on the IPU. This not only reduces traffic between platforms: it also supports more consistent and autonomous operator management. The IPU is provided access to a consistent (and attested) catalog of operators. Hence, users or software entities can submit operator request to the IPU to execute specific operators from a trusted catalog. Those operators are fetched from the catalog and validated via the attestation and validation operations described herein prior to execution on the IPU or forwarding a validated operator to be executed by a processing unit on the platform/node.

The IPU also includes logic that can monitor the status of the platform and the services in order to execute certain operators on certain platforms partitions (or the whole platform) or services when specific conditions are identified (e.g., using platform or application telemetry as a trigger).

The architecture also envisions that those capabilities can be managed in a multi-tenant configuration. For instance, configuring rules or management of the operators per tenants or groups of tenants.

Returning to FIG. 3, at a top level, architecture 300 includes a platform 302 having a CPU 304 and an IPU 306 communicatively coupled to an operator attestation service 308 and an operator catalog 310. CPU 304 includes a CXL (Compute Express Link) hub 312 coupled to one or more CXL DIMMs 314, and a pair of active bridges with HBM (High Bandwidth Memory) input/output (I/O) interfaces 316 and 317 coupled to HBM devices 318. High Bandwidth Memory is a high-speed computer memory interface for 3D-stacked synchronous dynamic random-access memory (SDRAM). Generally, HBM device 318 is illustrative of an HBM device implementing any existing and future HBM standard, including HBM, HBM2, HBM2E, HBM3, and HBM-PIM. Under an alternative configuration, CPU 304 includes one or more memory controllers coupled to DRAM or SDRAM. CPU 304 also includes other components and blocks common to modern processors/SoC architecture including multiple cores and a cache hierarchy, which are not shown for simplicity.

Generally, CPU 304 is used to execute platform software comprising an operating system and associated components that are used to run one or more applications. The platform software may also be deployed in a virtual execution environment employing a Type-1 or Type-2 hypervisor or in a container-based execution environment.

IPU 306 includes operator attestation and validation logic 320, operator execution logic 322, and monitoring and conditional operator trigger logic 324. IPU 306 is used in conjunction with a TOM 325 that signs attestation hashes (or digests containing the hashes concatenated with other data such as operator IDs and optional operator meta-data) using a certificate 327. Certificate 327 is illustrative of one or more certificates, which may include certificates generated by and/or used by TOM 325 and certificates that are provisioned to either IPU 306 or platform 302. In alternate embodiments, TOM 325 is a separate component (as shown) or integrated on IPU 306.

Operator attestation service 308 includes one or more secure IP servers 326 that are linked in communication with platform 302 over a secure authentication channel 328. Communications exchanged over secure authenticated channel 330 are used to perform operator attestation 330 using certificates 332.

Operator catalog 310 comprises a catalog (e.g., database) of operators that are hosted by one or more secure IP servers 334, which is/are linked in communication with platform 302 over a secure authenticated channel 336. A pull operator 338 implemented over secure authenticated channel 336 is used to fetch/retrieve (pull) operators in operator catalog 310. Secure IP server(s) 334 also uses certificates 340.

During runtime operations, IPU 306 may receive inputs from an external server or node, orchestrator, MANO, or the like, such as illustrated by a DeployOperator input 342 containing an operator identifier (ID) and parameters instructing the IPU to deploy an operator. IPU 306 may also receive operator flows 344 containing commands to execute a particular operator or perform a particular operation with an operator. In some embodiments the version of the operator is also included.

In addition to deploying operators on compute platforms with CPUs, the teaching and principles disclosed herein may be applied to Other Processor/Processing Units (collectively termed XPUs) including one or more of Graphic Processor Units (GPUs) or General Purpose GPUs (GP-GPUs), Tensor Processing Unit (TPU), Data Processor Units (DPUs), Artificial Intelligence (AI) processors or AI inference units and/or other accelerators, FPGAs and/or other programmable logic (used for compute purposes), etc. While some of the diagrams herein show the use of CPUs, this is merely exemplary and non-limiting. Generally, any type of XPU may be used in place of a CPU in the illustrated embodiments. Accordingly, as used in the following claims, the term “processor unit” is used to generically cover CPUs and various forms of XPUs.

FIG. 3a shows an architecture 300a including a platform 302a having an XPU 305 in place of CPU 304 in platform 302 of FIG. 3. In one embodiment, XPU 305 includes CXL hub 312 coupled to one or more CXL DIMMs 314. In another embodiment, XPU 305 does not include a CXL hub coupled to CXL DIMMs.

A compute platform also may include a CPU in combination with an XPU or multiple CPUs and/or XPUs. FIG. 3b shows an example of a platform 302b including a CPU 304 and an XPU 305. As above, XPU 305 may or may not include a CXL hub 312 and CXL DIMMs 314.

Generally, under the embodiments of FIGS. 3a and 3b IPU 306 may be used for attestation and validation of operators to be executed on the IPU and/or to be executed on XPU 305 (and CPU 304 for the platform 302a). Various types of operators may be deployed using various types of XPUs, including but not limited to software-based operators and bitstreams used to program FPGAs or other types of programmable logic devices.

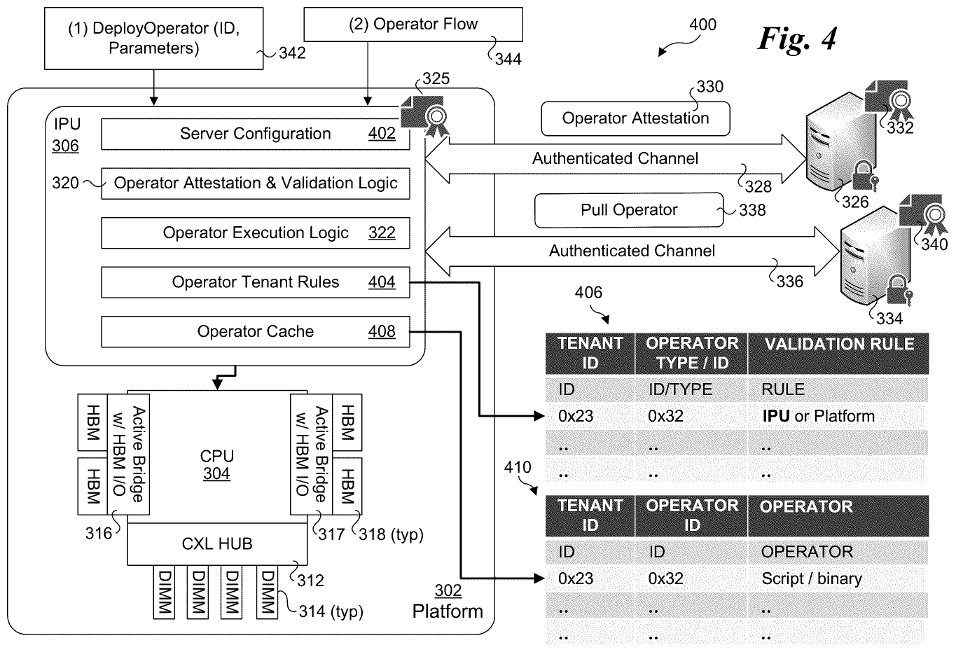

FIG. 4 shows an architecture 400 focusing on further details of IPU 306 and how it performs attestation of operators and other functions. IPU 306 now further includes server configuration logic 402, operator tenant rules 404 that uses an associated operator tenant rules table 406 and an operator cache 408 that uses an operator cache table 410.

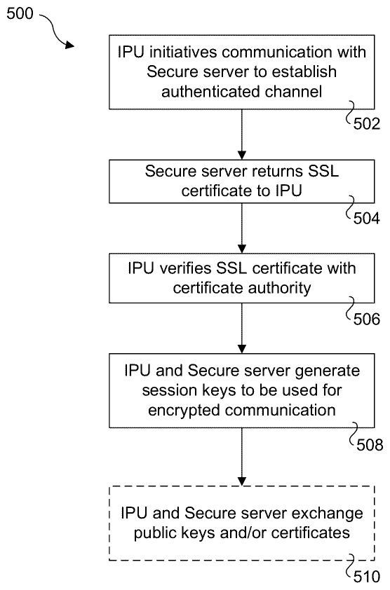

Server configuration logic 402 includes an interface that enables IPU 306 to configure the secure server or servers that can be used for attesting the operators that are being executed or router through the IPU, as depicted by secure IP servers 326 and 334. In one embodiment this includes an IP address for the secure server(s) and a certificate to validate the attestation results. Server configuration logic 402 is also used to establish authenticated channels 328 and 336 as shown in flowchart 500 of FIG. 5.

In some embodiments an authenticated channel employs an encrypted channel using SSL (secure sockets layer). In another embodiment, an authenticated channel comprises a virtual private network (VPN) link that is established using known techniques. In one embodiment, messages are exchanged over an authenticated channel using the HTTPS protocol.

In one embodiment, an authenticated channel employing SSL is established using a TSL handshake, as is known in the art. During platform initialization and/or an IPU provisioning operation, the IPU will be provided with IP addresses for secure servers used for the operator attestation service and operator catalog, such as depicted by secure (IP) servers 326 and 334 in the figures herein. In a block 502 the IPU initiates communication with a secure server to establish an authenticated channel between the IPU and the secure server. In a block 504 the secure server returns its SSL certificate to the IPU. In a block 506 the IPU verifies the SSL certificate with a certificate authority (operated by an external server and/or service not shown in the figures herein). Following verification of the SSL certificate the IPU and secure server generate session keys to be used for an encrypted communication session over the authenticated channel.

In an optional block 510 the IPU and secure server exchange public keys and/or certificates that will be used for authenticating messages sent for the other IPU and secure server. In some embodiments, the public keys/certificates may be provisioned to the IPU and the secure server(s) in advance, in which case the operation of block 510 will not be used.

Returning to FIG. 4, operator tenant rules 404 includes a second interface that supports registering an operator validation rule. The validation rules and an associated tenant ID and operator type/ID are stored in operator tenant rules table 406. A validation rule is something that the infrastructure owner can register in order to decide which operators and what particular operations within a particular operator (type of operator or user execution a particular operator) can be performed. In one embodiment this includes:
1. The ID for the tenant to which the rule applies. It can be targeted for specific tenants or users. Or it can apply to any user performing a particular operator. The tenant ID is stored in the TENANT ID field of operator tenant rules table 406.
2. The operator ID or operator type. This provides a way to identify when the particular rule needs to be executed. This can be either a particular operator ID or a particular operator type. An operator type can be something established by the operator owner or provider. An operator ID or operator type value is stored in the OPERATOR TYPE/ID field of operator tenant rules table 406.
3. The rule that needs to be executed to validate operations or operator execution when they are detected. In one embodiment the rule can be a Boolean rule that is applied to the fields or meta-data that goes along with the operator (e.g., operator type, user etc.) or it can be something more complex such as binary to be executed. In this later case, when the rule needs to be executed with operator request will be provided to the rule.

In the example of operator tenant rules table 406 in FIG. 4, the validation rule is a Boolean rule indicating whether the operator should be executed on the IPU or platform (e.g., CPU or XPU on the platform). In this example IPU is bolded indicating the rule indicates the operator with an ID type of 0x32 is to be executed on the IPU.

IPU 306 also includes an Application Program Interface (API) that enables requiring the execution of a particular operator. In one embodiment this interface includes:
1. Meta-data associated to the request. E.g., user requesting the execution, certificate of the user and signature of the request.
2. The operator to be executed. This can be either the operator UUID or the operator itself (e.g., an ansible script).

Operator cache 408 is used to cache the various operators that are executed over time using the third interface. In one embodiment, this cache will include a list of operators with:
1. The tenant ID that is related to the operator, stored in the TENANT ID field.
2. The operator UUID (Unique Universal Identifier) stored in the OPERATOR ID field.
3. The operator itself (which can be binary etc.) stored in the OPERATOR field.
4. Optionally, operator cache table 410 may include other fields such as expiration within the cache etc.

Operator attestation and validation logic 320 is responsible for validating operators and/or associated operations by performing client-side attestation and validation operation in cooperation with an operator attestation service on which server-side attestation and validation operations are performed. This logic is responsible for attesting and validating a particular operator, or operation within an operator or operator flow instantiated by a particular source.

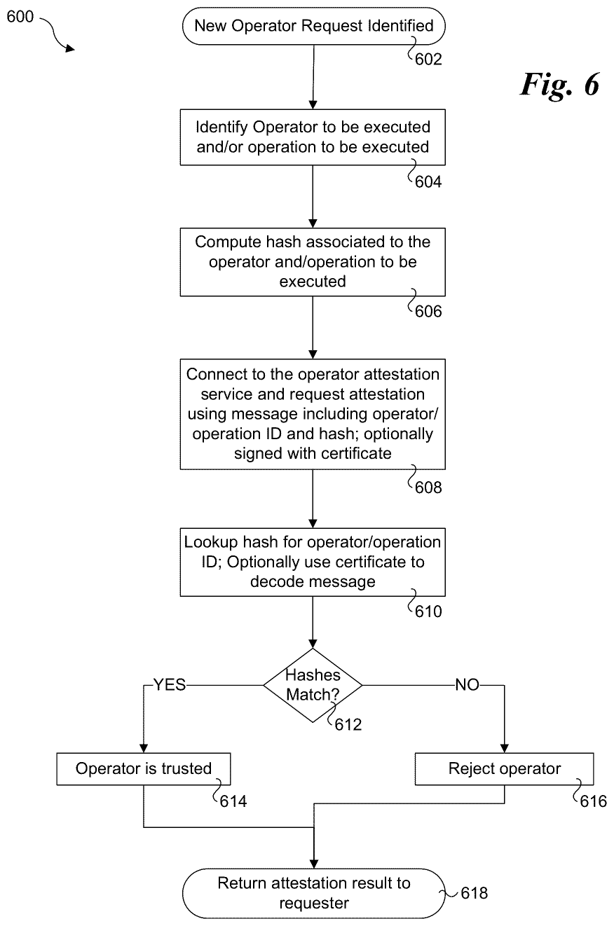

In one embodiment, the process for attesting and validating a particular operator or operation within an operator or operator flow instantiated by a particular source is shown in flowchart 600 of FIG. 6. The process begins in a start block 602 in which a new operator request is identified. In a block 604 the operator to be executed and/or the operation to be executed is identified. In a block 606 a hash associated with the operator and/operation to be executed is computed. For example, in one embodiment the hash is computed over the operator and/or operation code including any payload (if such exists). In a block 608 the attestation and validating logic connects to the operator attestation service and request attestation of the operator and/or operation to be executed. In one embodiment, the connection is established in the manner described above in flowchart 500 of FIG. 5. The operator/operation ID along with the hash is then sent in a message (separate or in a digest) to the operator attestation service. If a certificate exchange was performed in connection with establishing the authenticated channel, the digest may be signed with the certificate for the IPU or a certificate for the platform or node.

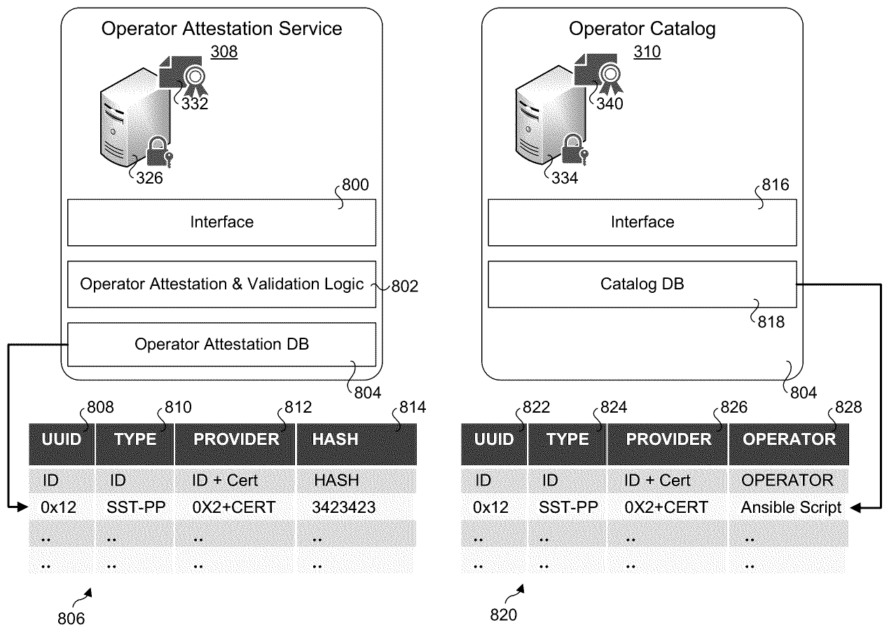

In a block 610 the operator attestation service extracts the ID and hash from the message, optionally using its copy of the certificate or public key to encode the digest if the digest was signed using the platform/node certificate. The ID is used as a lookup into a hash table stored at the operator attestation service that includes operator/operation ID/hash value pairs, as further shown and discussed in FIG. 8 below. The hash from the table is returned and compared with the hash in the message. As depicted in a decision block 612, a determination is made to whether the hashes match. If they match, the answer to decision block 612 is YES, and the logic proceeds to a block 614 indicating the operator is trusted. If the answer to decision block 612 is NO, the operator is rejected, as shown in a block 616. Subsequently, the attestation result of trusted or rejected is returned to the requester in an end block 618 as a message that may (optionally) be signed with the secure server's certificate.

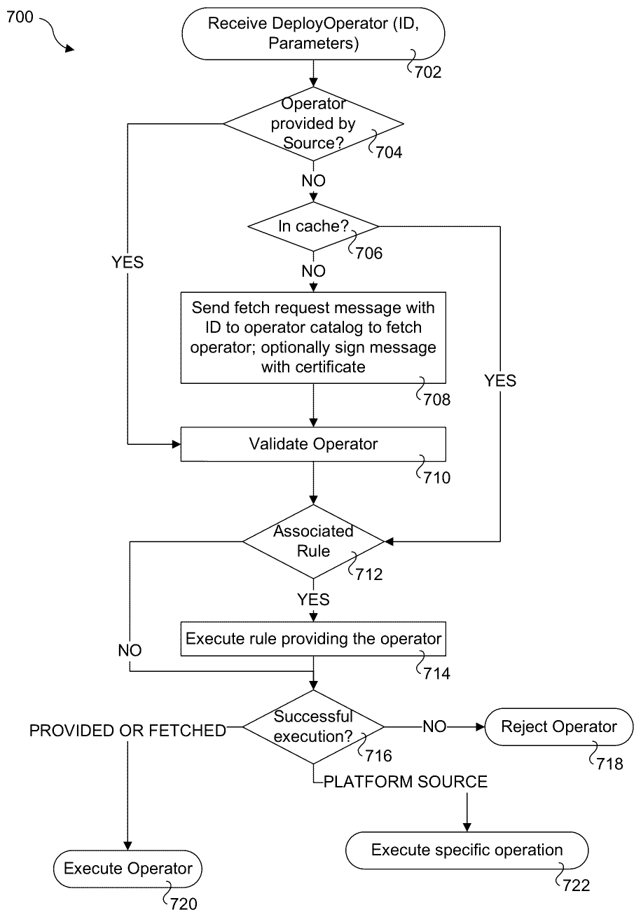

Operator execution logic 322 is responsible for performing the execution of an operator and or/or an operation of an operator. On a new operator request it will perform the operation and logic shown in flowchart 700 of FIG. 7.

As shown in a start block 702 a new operator request is received. In this example, a Deploy Operator message is received including an operator ID and applicable parameters. In some instance, the new operator itself may be provided by the source with the request. In a decision block 704 a determination is made whether the operator is provided by the source. If so, the answer to decision block 704 will be YES, and the logic will proceed to block 710 to validate the operator.

Next, a determination is made to whether the operator is in the operator cache. If the answer is NO, the logic proceeds to block 708. If the operator is in the operator cache, the logic proceeds to a decision block 712. In another embodiment, the order of decision blocks 704 and 706 is reversed.

In block 706 the operator is fetched from the operator catalog by sending a message over authenticated channel 336 to secure IP server 334 with the operator ID provided in start block 702. The message may be optionally signed with the IPU or platform/node certificate. The operator catalog will extract the ID from the message, optionally authenticating the message with its copy of the platform node certificate or associated public key. The operator catalog will look up the ID in its database of operators and return the operator in a reply message over authenticated channel 336 if an operator with the ID is found.

In block 710 the operator is validated by operator attestation and validation logic 320 by implementing the operations and logic in flowchart 600 discussed above. The remaining operations presumes the attestation result indicates the operator is trusted.

In decision block 712 a determination is made to whether there is any rule associated with the operator (either tenant or tenant plus operator). If there is an associated rule, the rule providing the operator is executed in a block 714. If there isn't an associated rule, the logic proceeds to a decision block 716 with an outcome of a successful execution.

In decision block 716 a determination is made to whether execution of the rule providing the operator is successful. If it is not, the logic proceeds to an end block 718 in which the operator is rejected. If the execution of the rule providing the operator is successful, the logic will proceed to execute the operator in an end block 720 if the operator was provided or fetched. If the operator is provided by a platform source, a specific operation of the operator is executed in an end block 722. As discussed above, depending on the validation rule in operator tenant rules table 406 (and if applicable), the operator or specific operation may be executed on the IPU or may be executed on the platform CPU or XPU.

FIG. 8 shows further details of the components used by operator attestation service 308 and operator catalog 310, according to one embodiment. Operator attestation service 308 is implemented using one or more secure IP servers 326, each either having a set of certificates 332 or having access to a shared set of certificates 332.

The components on a secure IP server 326 include an interface 800, operator attestation and validation logic 802, and an operator attestation database (DB) 804. Interface 800 is used to establish authenticated channel 328 and send and receive messages over authenticated channel 328 (including optional use of certificates used to sign digest in messages and for decrypting signed digests). In one embodiment interface 800 may be implemented in an HTTPS server.

Operator attestation and validation logic 802 is the counterpart of operator attestation and validation logic 320 and performs the service side attestation and validation operations. Generally, operator attestation and validation logic 802 may be implemented as a software application or service in a secure IP server 326. Operator attestation DB 804 comprises a database of operator attestation data hosted on a secure IP server 326 (or otherwise hosted on a separate server that is accessed by a secure IP server 326). Operator attestation DB 804 includes a table 806 having a UUID field 808 containing an ID, a TYPE field 810 containing a type ID, a PROVIDER field 812 containing a provider ID concatenated with a certificate, and a HASH field 814 containing a hash value.

Operator catalog 310 is implemented using one or more secure IP servers 334, each either having a set of certificates 340 or having access to a shared set of certificates 340. The components on a secure IP server 334 include an interface 816 and a catalog DB 818. Interface 816 is used to establish authenticated channel 336 and send and receive messages over authenticated channel 336 (including optional use of certificates used to sign digests contained in messages). In one embodiment interface 816 may be implemented in an HTTPS server.

Catalog DB 818 includes a table 820 having a UUID field 822 including an ID, a TYPE field 824 including a Type ID, a PROVIDER field 826 containing a concatenation of a Provider ID and a provider certificate, and an OPERATOR field 828 containing an operator such as an Ansible script, a binary (machine executable) operator, or a bitstream used to program an FPGA or similar accelerator.

In some of the foregoing embodiments, a digest comprising an operator ID+hash is generated, signed using a certificate, and encapsulated in a message. Under an optional approach, the digest may include additional meta-data for the operator, such as operator type, operator version, tenant information, and/or provider information.

### Example IPU/SmartNIC

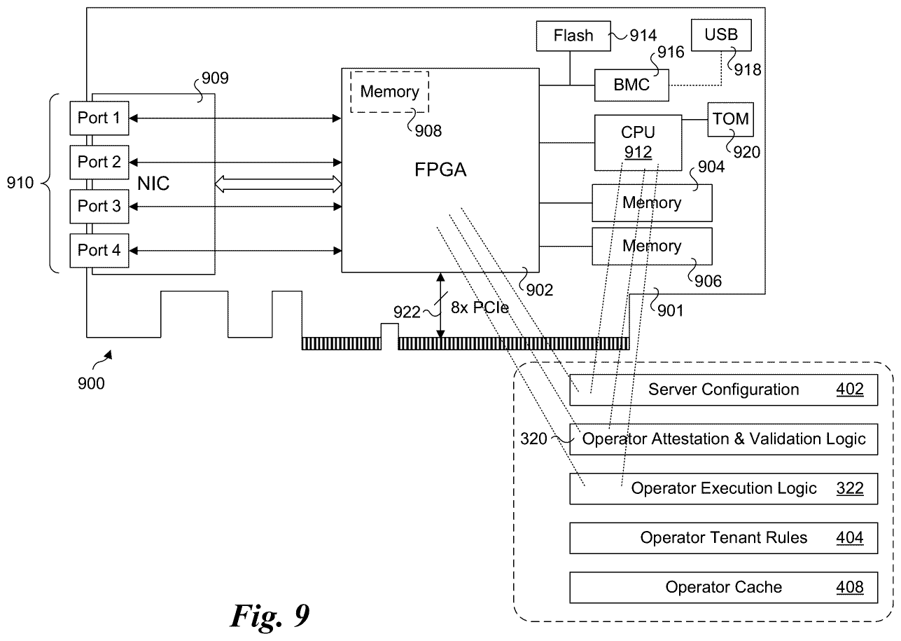

FIG. 9 shows an example IPU 900, which also may be called a SmartNIC, according to one embodiment. IPU 900 includes multiple components that are coupled to a circuit board 901. The components include an FPGA 902 that may be programmed to implement various logic described herein. Generally, an FPGA may access data stored in one or more memory devices, such as depicted by memory devices 904 and 906. As described below, various types of memory devices may be used, including but not limited to DDR4 and DDR5 DIMMS (Dual Inline Memory Modules). The FPGA may also include onboard memory 908 in which data may be stored.

In the illustrated embodiment, IPU 900 includes a NIC chip 909 with four network ports 910, respectively labeled Port 1, Port 2, Port 3, and Port 4. Data can be transferred between NIC chip 909 and FPGA 902 using separate links per network port 910 or using a multiplexed interconnect. In one embodiment, NIC chip 909 employs a 40 GB/s MAC, and each of the four network ports 910 is a 10 GB/s port. In other embodiments, NIC chip 909 may employ a MAC with other bandwidths. Also, the illustrated use of four ports is merely exemplary and non-limiting, as a IPU may have various numbers of network ports. In some embodiments, an IPU may include multiple NIC chips.

IPU 900 further includes a CPU 912 flash memory 914, a baseboard management controller (BMC) 916, a USB module 918, and a TOM 920. CPU 912 may be used to execute embedded software/firmware or the like. Flash memory 914 may be used to store firmware and/or other instructions and data in a non-volatile manner. Other software may be loaded over a network coupled to one or more of the NIC ports.

In the illustrated embodiment, FPGA 902 has a PCIe interface that is connected to a PCIe edge connector configured to be installed in a PCIe expansion slot. In one embodiment, the PCIe interface comprises an 8 lane (8×) PCIe interface 922. Other PCIe interface lane widths may be used in other embodiments, including 16 lane (16×) PCIe interfaces.

In some embodiments, a portion of the FPGA circuitry is programmed to implement one or more of server configuration logic 402, operator attestation and validation logic 320 and operator execution logic 322. Optionally, similar logic may be implemented via execution of associated software/firmware on CPU 912. Other logic and operations described in the foregoing embodiment may be implemented using FPGA 902, CPU 912, or a combination of the two. FPGA circuitry on FPGA 902 and/or execution of embedded software/firmware on CPU 912 may also be used to implement/execute operators.

Operator tenant rules 404 and operator cache 408 may be stored in memory 904, 906, or 908, depending on the particular implementation. A backup copy of these data may also be periodically written to flash 914.

Volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). A memory subsystem as described herein can be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/Output version 2, JESD229-2 originally published by JEDEC in August 2014, HBM (High Bandwidth Memory, JESD325, originally published by JEDEC in October 2013, DDR5 (DDR version 5), LPDDR5, HBM2E, HBM3, and HBM-PIM, or others or combinations of memory technologies, and technologies based on derivatives or extensions of such specifications. The JEDEC standards are available at www.jedec.org.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Tri-Level Cell (“TLC”), Quad-Level Cell (“QLC”), Penta-Level Cell (PLC) or some other NAND). A NVM device can also include a byte-addressable write-in-place three dimensional crosspoint memory device, or other byte addressable write-in-place NVM devices (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As discussed above, various aspects of the embodiments herein may be facilitated by corresponding software and/or firmware components and applications, such as software and/or firmware executed by an embedded processor or the like. Thus, embodiments of this invention may be used as or to support a software program, software modules, firmware, and/or distributed software executed upon some form of processor, processing core or embedded logic or a virtual machine running on a processor or core or otherwise implemented or realized upon or within a non-transitory computer-readable or machine-readable storage medium. A non-transitory computer-readable or machine-readable storage medium includes any mechanism for storing or transmitting information in a form readable by a machine (e.g., a computer). For example, a non-transitory computer-readable or machine-readable storage medium includes any mechanism that provides (i.e., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A non-transitory computer-readable or machine-readable storage medium may also include a storage or database from which content can be downloaded. The non-transitory computer-readable or machine-readable storage medium may also include a device or product having content stored thereon at a time of sale or delivery. Thus, delivering a device with stored content, or offering content for download over a communication medium may be understood as providing an article of manufacture comprising a non-transitory computer-readable or machine-readable storage medium with such content described herein.

The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A: B: C: A and B: A and C: B and C: or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1.-20. (canceled)

21. An apparatus configured to be implemented in a compute platform including at least one processing unit, the apparatus comprising circuitry and logic to:
perform attestation operations with an operator attestation service coupled to the compute platform over a first authenticated channel to validate an operator to be executed on the apparatus or a processing unit on the compute platform, wherein the apparatus interacts with the operator attestation service to attest to the validity of the operator; and
when the operator is attested to as valid, one of execute the operator or forward the operator to the processing unit on which the operator is to be executed.

22. The apparatus of claim 21, wherein the circuitry and logic are further to:
establish a second authenticated channel coupled between the platform and an operator catalog having an operator database in which a plurality of operators is stored;
fetch, from the operator catalog, an operator by sending a message containing an identifier (ID) for the operator, wherein in response to the message the operator catalog returns an operator corresponding to the operator ID; and
perform attestation operations with the operator attestation service to validate the operator that is fetched from the operator catalog.

23. The apparatus of claim 21, wherein performing attestation operations comprises:
computing a hash over content including the operator;
sending a first message over the first authenticated channel to the operator attestation service including the hash and an operator identifier (ID); and
receiving a second message from the operator attestation service indicating whether the operator is valid.

24. The apparatus of claim 23, wherein performing attestation operations further comprises:
generating a digest comprising the operator ID and the hash;
signing the digest with a certificate allocated to one of the apparatus and the platform; and encapsulating the signed digest in the first message.

25. The apparatus of claim 21, wherein the apparatus is configured to be implemented in a compute platform deployed in a multi-tenant environment, further comprising circuitry and logic to maintain and enforce a set of operator tenant rules as applied to operators associated with particular tenants to be executed on the apparatus or to be executed on a processing unit in the platform.

26. The apparatus of claim 21, further comprising circuitry and logic to implement an operator cache, wherein the operator cache is used to cache operators that have been attested to as valid operators.

27. The apparatus of claim 21, wherein the at least one processing unit comprises another processing unit (XPU) comprising a Graphic Processor Unit (GPU), a General Purpose GPU (GP-GPU), a Tensor Processing Unit (TPU), a Data Processor Unit (DPU), an Artificial Intelligence (AI) processor or AI inference unit, and a Field Programmable Gate Array (FPGA).

28. The apparatus of claim 21, wherein the apparatus comprises at least one of a network adaptor, a network interface controller, and an infrastructure processing unit (IPU).

29. A method implemented by an apparatus on a compute platform including one or more processing units separate from the apparatus, comprising:
performing client-side attestation operations with an operator attestation service coupled to the compute platform over a first authenticated channel to validate an operator to be executed on the apparatus or a processing unit on the compute platform, wherein the apparatus interacts with the operator attestation service to attest to the validity of the operator; and
when the operator is attested to as valid, one of executing the operator or forwarding the operator to the processing unit on which the operator is to be executed.

30. The method of claim 29, further comprising:
establishing a second authenticated channel coupled between the platform and an operator catalog having an operator database in which a plurality of operators is stored;
fetching, from the operator catalog, an operator by sending a message containing an identifier (ID) for the operator, wherein in response to the message the operator catalog returns an operator corresponding to the operator ID; and
performing client-side attestation operations with the operator attestation service to validate the operator that is fetched from the operator catalog.

31. The method of claim 29, wherein performing client-side attestation operations comprises:
computing a hash over content including the operator;
sending a first message over the first authenticated channel to the operator attestation service including the hash and an operator identifier (ID); and
receiving a second message from the operator attestation service indicating whether the operator is valid.

32. The method of claim 31, wherein performing client-side attestation operations further comprises:
generating a digest comprising the operator ID and the hash;
signing the digest with a certificate allocated to one of the apparatus and the platform; and
encapsulating the signed digest in the first message.

33. The method of claim 29, wherein the apparatus is configured to be implemented in a compute platform deployed in a multi-tenant environment, further comprising maintaining and enforcing a set of operator tenant rules as applied to operators associated with particular tenants to be executed on the apparatus or to be executed on a processing unit in the platform.

34. The method of claim 29, further comprising implementing an operator cache to store and provide access to operators that have been attested to as valid operators.

35. The method of claim 29, wherein the at least one processing unit comprises another processing unit (XPU) comprising a Graphic Processor Unit (GPU), a General Purpose GPU (GP-GPU), a Tensor Processing Unit (TPU), a Data Processor Unit (DPU), an Artificial Intelligence (AI) processor or AI inference unit, and a Field Programmable Gate Array (FPGA)

36. The method of claim 29, wherein the apparatus comprises a network adaptor or network interface controller.

37. A compute platform comprising:
one or more processing units;
a network interface controller (NIC), coupled to at least one of the one or more processing units comprising circuitry and logic to:
perform attestation operations with an operator attestation service coupled to the compute platform over a first authenticated channel to validate an operator to be executed on the apparatus or a processing unit on the compute platform, wherein the apparatus interacts with the operator attestation service to attest to the validity of the operator; and
when the operator is attested to as valid, one of execute the operator or forward the operator to the processing unit on which the operator is to be executed.

38. The compute platform of claim 37, wherein the circuitry and logic on the NIC are further to:
establish a second authenticated channel coupled between the platform and an operator catalog having an operator database in which a plurality of operators is stored;
fetch, from the operator catalog, an operator by sending a message containing an identifier (ID) for the operator, wherein in response to the message the operator catalog returns an operator corresponding to the operator ID; and
perform attestation operations with the operator attestation service to validate the operator that is fetched from the operator catalog.

39. The compute platform of claim 37, wherein performing attestation operations comprises:
computing a hash over content including the operator;
sending a first message over the first authenticated channel to the operator attestation service including the hash and an operator identifier (ID); and
receiving a second message from the operator attestation service indicating whether the operator is valid.

40. The compute platform of claim 39, wherein performing attestation operations further comprises:
generating a digest comprising the operator ID and the hash;
signing the digest with a certificate allocated to one of the apparatus and the platform; and
encapsulating the signed digest in the first message.
